(19) United States
(12) Patent Application Publication
(10) Pub. No.: US 2024/0095018 A1
(43) Pub. Date: Mar. 21, 2024

(54) METHOD FOR OPERATING A CONTROL DEVICE, AND CONTROL DEVICE

(71) Applicant: Robert Bosch GmbH, Stuttgart (DE)

(72) Inventor: Jan Pepke, Remseck A.n. (DE)

(21) Appl. No.: 18/546,537

(22) PCT Filed: Feb. 14, 2022
(86) PCT No.: PCT/EP2022/053469

§ 371 Date: Aug. 15, 2023

(30) Foreign Application Priority Data
Mar. 3, 2021 (DE) 10 2021 202 015.1

(51) Int. Cl. G06F 8/65

(52) U.S. Cl. CPC G06F 8/65

(57) ABSTRACT

A method for operating a control device for a vehicle, in which software in a first version intended for an operation of the control device and an item of control information are stored. The control device is developed to receive the software intended for the operation of the control device in a second version, which differs from the first version, and to store it in a memory unit, the second version being identifiable by an indication identifying the software. The method includes: receiving at least one indication which identifies the software to be installed; checking whether storing of the software to be installed is permitted based on the indication identifying the software to be installed and the control information; and if the storing of the software to be installed is permitted, storing the software to be installed in the memory unit.

### FIELD

The present invention relates to a method for operating a control device, in particular a vehicle control device, and to a control device and a computer program for its execution.

### BACKGROUND INFORMATION

Modern vehicles are equipped with a steadily growing number of control devices, which are also networked with one another to an increasing extent. In this context, software or firmware updates over-the-air (SOTA/FOTA), in which a new version of a software of a control device is no longer installed locally but can be installed on the control device through a wireless data link, are possible.

### SUMMARY

According to the present invention, a method for operating a control device as well as a control device and a computer program for its execution are provided. Advantageous embodiments of the present invention are disclosed herein.

The present invention relates to control devices for vehicles (or motor vehicle control devices) and their operation and possible problems in the updating of software. Especially when more complex control device functions are involved, a multitude of tests is required to allow for the comprehensive testing of a software or a system made up of a plurality of distributed control devices. The reason for this is that the ever-greater networking produces a steadily growing number of potential error sources, which must—or should—be checked. Based on the risks, only a certain portion of the software is therefore able to be tested, and safety-relevant software be redundantly plausibilized or plausibilized in a simplified fashion.

In this context, new software, that is, a new version of a software of a control device, normally has a greater likelihood of undetected malfunctions. For that reason, complex and time-consuming tests must be carried out in order to check a new software or a new version of a software under the greatest number of environmental conditions. But even then, it cannot be ruled out that errors will occur during a later operation.

Further risks result from the mutual networking because software on other processing units may also be affected by an update of a control device and suddenly exhibit malfunctions themselves in the wake of such an update. Especially when updates are to be carried out on networked functions, the software of numerous control devices in the network must often be replaced so that an uninterrupted compatibility can be ensured.

Against this background, it is now provided within the framework of the present invention that a control device for a vehicle (or a vehicle control device) has control information available (such as a data packet), which is evaluated during or prior to the installation of a new software, so that a decision can be made whether the installation of the software should be allowed. In an advantageous manner, such control information may especially be used to also enable and control a downgrade or rollback. Depending on the type of control devices installed in the vehicle, a downgrade of the software, that is, the (external) installation of the/a prior software, or a rollback, that is, a control-device-internal restoration of the/or prior version of the software, may be a useful measure until an error-free new version of the software is available. However, it is normally not practical to allow random prior versions because these may include errors themselves, or incompatibilities may have arisen in the meantime. The use of the control information then particularly makes it possible to control the options for a downgrade or rollback and to allow only specific software versions or to prohibit specific software versions. For example, if a certain software version must be urgently pulled out of circulation because it represents a high security risk (with regard to safety or security), then the framework of the present invention creates a possibility for preventing a downgrade or a rollback to this particular version (and also an upgrade to such) in the future.

In greater detail, the present invention relates to a method for operating a control device for a vehicle in which a software in a first version intended for the operation of the control device and an item of control information are stored, and the control device is set up to receive software provided for the operation of the control device in a second version which differs from the first version, and to store it in a memory unit, the second version being identifiable by an indication identifying the software. According to an example embodiment of the present invention, the method includes receiving at least one specification identifying a software to be installed; checking whether storing of the software to be installed is permitted based on the indication identifying the software to be installed and the control information; and if the storing of the software to be installed is permitted, storing the software to be installed in the memory unit.

According to an example embodiment of the present invention, the control information preferably includes identifying information, such as information about software versions or revisions, about software that may be installed on the control device (known as a whitelist), and/or software that may not be installed on the control device (known as a blacklist). In particular, both types of indications or only one of the two may exist together with an item of information specifying which type of indication (i.e., permitted or not permitted; whitelist or blacklist) is involved. In this way, there will be no need to provide memory areas in the control information for both types of lists, which means that the control information remains limited in its memory requirement.

According to an example embodiment of the present invention, the installation preferably relates to an update or upgrade, that is, the new software is more recent (in particular has a higher version number or revision number) or it relates a downgrade or rollback, that is, the new software is older (in particular has a lower version number or revision number). It should be pointed out that the specific identification or versioning schema is not important in the present invention. Relevant is only that the software can be identified.

However, the control device is specifically set up to always accept and install software in a newer version than the currently existing software (i.e., updates), but to allow older versions (i.e., downgrades) only if it is permitted by the control information.

According to an example embodiment of the present invention, an installation of a new software is preferably carried out only if the control information includes data or if data is available, which means that if an indication identifying the software is missing, then the storing of the software in the memory unit will not be permitted by the control device.

According to an example embodiment of the present invention, the control information preferably also includes age information (e.g., also known as a freshness counter) to prevent replay attacks (making old and possibly no longer valid control information available). The age information may include a date, in particular.

According to an example embodiment of the present invention, the control information is preferably received by the control device in encrypted and/or signed form and/or is stored in the control device so that an accidental or intentional manipulation can be prevented. Suitable encryption and signature algorithms are well known to one skilled in the art, e.g., on the basis of AES, SHA, etc.

The present invention offers a flexible option (the control information or the indications included therein may be prepared at any time by (authorized) persons and be adapted to the current findings with regard to critical software versions) and a secure option (replay-attack prevention, signing) for the control of upgrades and downgrades.

In this way, a software update for a control device may thus be undertaken without risk or at least at a reduced risk. If a malfunction occurs when the new software version is executed or if it occurs multiple times, a switch to the prior or old version of the software may take place for reasons of security, for example. This makes it possible to continue the operation, albeit possibly with slight restrictions (for instance if the old version has fewer functions or includes other errors, which, however, may possibly be less relevant than the errors of the new version). As a result, the number of tests with the new software version that must be carried out in advance may ultimately be able to be reduced.

The present invention is particularly suitable for software updates via radio. In the future, future software updates are not meant to be performed in a workshop, if possible. Instead, the vehicle is to download and install the new software or new software version itself via a radio link or a wireless connection without any significant intervention by the user (the mentioned SOTA/FOTA update). To this end, twice as much memory space as should minimally be available for the operation anyway is sometimes already required in the control device to download the new software in the background in the free memory area. As soon as the new software has been downloaded in its entirety, the new software is able to be used after a reboot. In this way, software updates are able to be carried without the user noticing it. The present invention could be implemented there without further hardware changes, for example if an earlier version remains stored in the control device.

The resulting overall reduction in the occurrence of malfunctions reduces the time and effort required for testing. New software updates can be installed in the vehicles earlier and more cost-effectively. In that way, it is less expensive for manufacturers to equip vehicles with new software functions even retroactively. This is of particular interest to the manufacturer if, for example, the manufacturer wants to employ new data for data-mining applications from as many vehicles as possible, which also means that software changes are required for vehicles that are already on the market.

A control device of a vehicle according to the present invention is developed, especially in terms of programming technology, to carry out a method according to the present invention.

Also advantageous is the implementation of a method according to the present invention in the form of a computer program or a computer program product having program code for carrying out all method steps because this minimizes the expense, in particular when an executing control device is also used for further tasks and thus is available anyway. Suitable data carriers for providing the computer program in particular are magnetic, optical and electric memories such as hard disks, flash memories, EEPROMs, DVDs and others A download of a program via computer networks (internet, intranet, etc.) is also an option.

Additional advantages and embodiments of the present invention result from the description and the figures.

The present invention is schematically illustrated in the figures based on an exemplary embodiment and described with reference to the figures in the following text.

### BRIEF DESCRIPTION OF THE DRAWINGS

FIG. 1 schematically shows control devices according to the present invention in preferred example embodiments in a vehicle.

FIG. 2 schematically shows a sequence of a method of the present invention in a preferred example embodiment.

### DETAILED DESCRIPTION OF EXAMPLE EMBODIMENTS

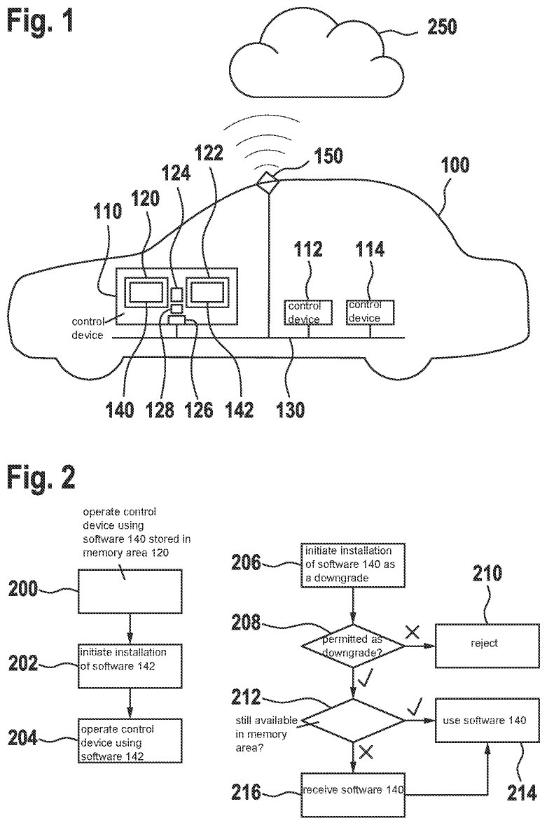

In FIG. 1, control devices 110, 112 and 114 are schematically illustrated in preferred embodiments in a vehicle 100. Only control device 110 will be described in greater detail as an example, but control devices 112, 114 may have the same development.

Control device 110 has a memory unit having multiple memory areas 120, 122; a processor 124; and a communication interface 126 by which it is connected to a communication medium such as a bus (e.g., a CAN bus). The other control devices are similarly connected to communications medium 130 so that it is possible to exchange messages in this way.

In addition, the vehicle has a data interface 150 such as for a radio transmission of data, e.g., for the communication with a remote processing unit, processing center, cloud, etc., which is symbolized by a cloud 250.

Two versions 140 and 142 of a software which is intended for the operation of control device 110 are now able to be stored on control device 110 in one of the memory areas 120, 122 in each case. In particular, the software may be received, or may have been received, in a wireless manner via interface 150, or also in the conventional way such as via a programming device connected to the CAN bus. As part of the respective software or independently thereof, the control device also has at least one item of control information 128 in the memory unit, with the aid of which the control device checks whether storing of software to be installed is permitted. The control information, too, can be newly installed on the control device, for example as part of a software or independently thereof.

For example, the control device is set up to always accept and install software in a newer version (e.g., having a higher version number) than the currently existing software, but older versions only if this is permitted by control information 128. To prevent unallowed accesses, the control device is usefully set up to accept data to be installed (such as the software and the control information) only in encrypted and/or signed form. Suitable mechanisms are known to one skilled in the art.

In FIG. 2, a sequence of a method according to the present invention is schematically shown in a preferred embodiment.

In a step 200, the control device is operated using a software 140 stored in memory area 120 of the memory unit, for instance.

In a step 202, the installation of some other software 142 may be initiated, for instance as an update to software 140. For this purpose, new software 142 is installed in the vehicle control device, for instance via data interface 150, and stored there in memory area 122 of the memory unit, for example. An updated item of control information 128 is particularly also installed together with software 142 which, for example, identifies the earlier software 140 as a permitted downgrade. To this end, control information 128 may include a list of all permitted downgrades (whitelist) and/or a list of all impermissible downgrades (blacklist), for instance.

In a step 204, the control device is operated using software 142 stored therein. Software 140 can then be deleted but for practical purposes will be retained to allow for its use should the need arise, provided it is identified as a permissible downgrade in the control information.

If a return to the prior or older software 140 then becomes necessary, for instance because serious errors have been encountered while software 142 was in operation, then an installation of software 140 as a downgrade to software 142 will be initiated in a step 206. This is usually undertaken from the outside such as by a control device or vehicle manufacturer (within 250).

Next, the control device first checks in a step 208 with the aid of control information 128 whether software 140 is permitted as a downgrade for software 142 in the first place.

If the software is not permitted, it will not be installed; the receiving of the software, for example, is already rejected in step 210.

However, if the software is permitted—as is the case of software 140—the control device checks especially whether this software is still available in the memory unit of the control device, i.e., in memory area 120 in this case, step 212.

If this is true in step 212, this software will be used, in particular after a reboot of the control device. The control device will then be operated, at least initially, using this version 140, step 214.

If this is not true in step 212, software 140 is received, in particular via data interface 150, stored in the memory unit of the control device, step 216, and used, especially after a reboot of the control device. The operation of the control device is then continued with this version 140, at least initially, step 214.

1-10. (canceled)

11. A method for operating a control device for a vehicle, in which software in a first version intended for operation of the control device and an item of control information are stored, the control device being configured to receive the software intended for the operation of the control device in a second version, which differs from the first version, and to store the second version in a memory unit, the second version being identifiable by an indication identifying the software, the method comprising the following steps:
receiving at least one indication identifying the software to be installed;
checking whether storing of the software to be installed is permitted based on the indication identifying the software to be installed and the control information; and
based on the storing of the software to be installed being permitted, storing the software to be installed in the memory unit.

12. The method as recited in claim 11, further comprising:
receiving the software to be installed from a control-device-external source, or reading out the software to be installed from the memory unit of the control device.

13. The method as recited in claim 11, wherein the receiving of the at least one indication identifying the software to be installed includes:
receiving the at least one indication identifying the software to be installed from a control-device-external source, or
reading out the at least one indication identifying the software to be installed from the memory unit of the control device.

14. The method as recited in claim 11, wherein the control information includes identifying information about software that may be installed on the control device and/or may not be installed on the control device.

15. The method as recited in claim 11, wherein the control information includes age information, which indicates the age of the control information.

16. The method as recited in claim 11, further comprising the following steps:
receiving the control information from a control-device-external source; and
storing the control information in the memory unit.

17. The method as recited in claim 16, wherein the control information is received in a cryptographically encrypted and/or signed form and/or stored.

18. A control device for a vehicle, in which software in a first version intended for operation of the control device and an item of control information are stored, the control device being configured to receive the software intended for the operation of the control device in a second version, which differs from the first version, and to store the second version in a memory unit, the second version being identifiable by an indication identifying the software, the control device configured to:
receive at least one indication identifying the software to be installed;
check whether storing of the software to be installed is permitted based on the indication identifying the software to be installed and the control information; and
based on the storing of the software to be installed being permitted, store the software to be installed in the memory unit.

19. A non-transitory machine-readable memory medium on which is stored a computer program for operating a control device for a vehicle, in which software in a first version intended for operation of the control device and an item of control information are stored, the control device being configured to receive the software intended for the operation of the control device in a second version, which differs from the first version, and to store the second version in a memory unit, the second version being identifiable by an indication identifying the software, the computer program, when executed by the control device, cause the control device to perform the following steps:
receiving at least one indication identifying the software to be installed;
checking whether storing of the software to be installed is permitted based on the indication identifying the software to be installed and the control information; and
based on the storing of the software to be installed being permitted, storing the software to be installed in the memory unit.
